(19) United States
(12) Patent Application Publication
(10) Pub. No.: US 2007/0263588 A1
(43) Pub. Date: Nov. 15, 2007

(54) Information processing apparatus and connection control method

(76) Inventors: Anwar Sathath, Ome-shi (JP); Keiji Kanamori, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/787,583

(22) Filed: Apr. 17, 2007

(30) Foreign Application Priority Data
Apr. 28, 2006 (JP) 2006-126416

(51) Int. Cl. H04J 3/24; H04L 12/56

(52) U.S. Cl. 370/349; 370/389

(57) ABSTRACT

According to one embodiment, there is an information processing apparatus comprising a load check portion which checks communication loads at a plurality of radio relay stations, and a connection processing portion which executes wireless connection with a radio relay station of a lowest communication load of the communication loads checked by the load check portion.

### CROSS-REFERENCE TO RELATED APPLICATIONS

This application is based upon and claims the benefit of priority from Japanese Patent Application No. 2006-126416, filed Apr. 28, 2006, the entire contents of which are incorporated herein by reference.

### BACKGROUND

1. Field

One embodiment of the invention relates to an information processing apparatus which allows communication via a radio relay station and also relates to a connection control method for the apparatus.

2. Description of the Related Art

In a radio communication environment including a plurality of radio relay stations (access points), a client (an information processing apparatus having a radio communication function) is generally connected to a relay station that is nearest to the client or that emits the strongest radio wave.

There are known art of displaying information of a plurality of clients on a screen. For example, Jpn. Pat. Appln. KOKAI Publication No. 2005-85110 discloses a technique relating to a network in which configurations of a plurality of terminal apparatuses dynamically change. In this technique, information on a plurality of terminal apparatuses is displayed on a screen, and the user can select a desired terminal apparatus through the screen.

When clients are connected to radio relay stations by radio waves in the method described above, there may be an occasion when a number of clients are connected to one radio relay station. In that case, the relay station is put under heavy load and a malfunction in communication may occur. Such a malfunction cannot be solved by the technique disclosed in the above prior art publication.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of a computer according to an embodiment of the present invention;

FIG. 2 is an exemplary diagram showing a system configuration of the computer;

FIG. 3 is an exemplary block diagram showing a functional configuration relating to a radio communication function of the computer;

FIG. 4 is an exemplary diagram showing an example of a radio communication environment, in which a plurality of clients are connected by radio waves to a plurality of preset access points;

FIG. 5 is an exemplary diagram showing a configuration of a data frame transmitted between a client and an access point shown in FIG. 4;

FIG. 6 is an exemplary diagram showing a result of an analysis performed by a client Cx shown in FIG. 4;

FIG. 7 is an exemplary diagram showing a result of a load check performed by the client Cx shown in FIG. 4;

FIG. 8 is an exemplary diagram showing a connection and load status displayed on the screen of the client Cx based on the result of the analysis shown in FIG. 6 and the result of the load check shown in FIG. 7;

FIG. 9 is an exemplary flowchart showing a mode setting operation;

FIG. 10 is an exemplary flowchart showing an operation of the automatic mode shown in FIG. 9;

FIG. 11 is an exemplary flowchart showing an operation of the manual mode shown in FIG. 9; and

FIG. 12 is an exemplary flowchart showing an operation of a load check shown in FIG. 11.

### DETAILED DESCRIPTION

Various embodiments according to the invention will be described hereinafter with reference to the accompanying drawings. In general, according to one embodiment of the invention, there is an information processing apparatus comprising a load check portion which checks communication loads at a plurality of radio relay stations, and a connection processing portion which executes wireless connection with a radio relay station of a lowest communication load of the communication loads checked by the load check portion.

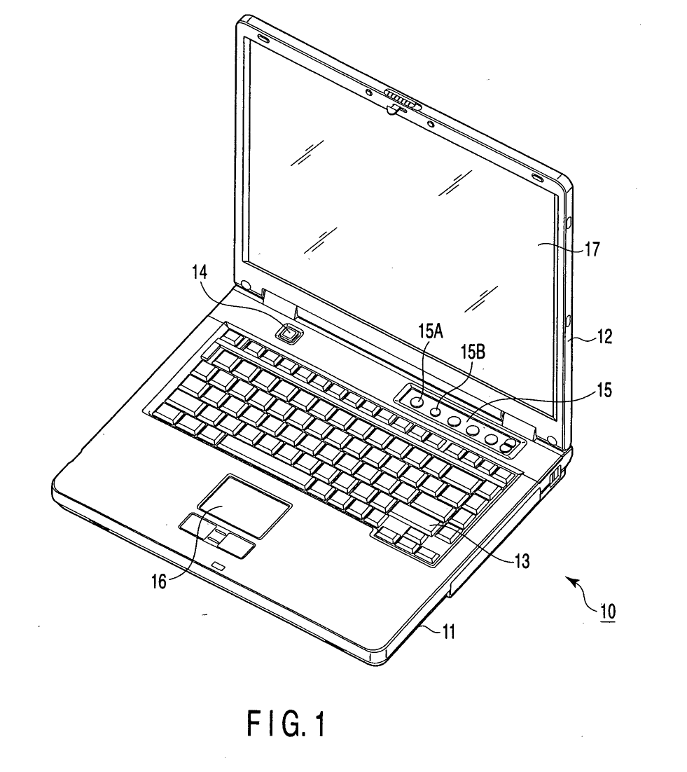

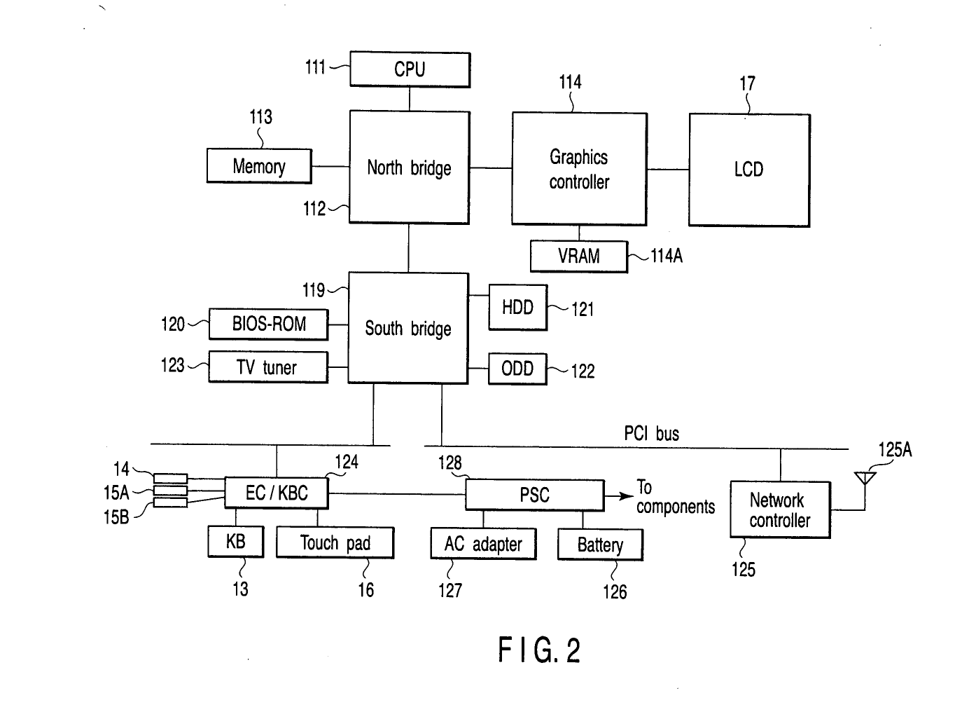

First, a configuration of an information processing apparatus according to an embodiment will be described with reference to FIGS. 1 and 2. The information processing apparatus is implemented as, for example, a notebook computer 10.

FIG. 1 is a perspective view showing a state in which a display unit of the notebook computer 10 is opened. The computer 10 comprises a computer main body 11 and a display unit 12. The display unit 12 incorporates a display device comprising a TFT-LCD (Thin Film Transistor Liquid Crystal Display) 17. The display screen of the LCD 17 is located substantially in the central portion of the display unit 12.

The display unit 12 is attached to the computer main body 11 so as to be rotatable between an open position and a closed position. The computer main body 11 has a thin box-shaped casing. The computer main body 11 comprises a keyboard 13, a power button 14 to power on/off the computer 10, an input operation panel 15, a touch pad 16, etc., which are arranged on an upper surface of the casing.

The input operation panel 15 is an input device, through which an event corresponding to a depressed button is input. It has a group of buttons to activate a plurality of functions, respectively. The group of buttons includes a TV activating button 15A and a DVD/CD activating button 15B. The TV activating button 15A is a button to activate TV function in order to play back, view, listen to and record TV broadcast program data. The DVD/CD activating button 15B is a button to play back video contents recorded in a DVD or CD.

A system configuration of the computer 10 will now be described with reference to FIG. 2.

As shown in FIG. 2, the computer 10 comprises a CPU 111, a north bridge 112, a main memory 113, a graphics controller 114, a south bridge 119, a BIOS-ROM 120, a hard disk drive (HDD) 121, an optical disk drive (ODD) 122, a TV tuner 123, an embedded controller/keyboard controller IC (EC/KBC) 124, a network controller 125, a battery 126, an AC adapter 127, a power supply controller (PSC) 128, etc.

The CPU 111 is a processor provided to control operations of the computer 10. It executes an operating system (OS) and various software loaded from the hard disk drive (HDD) 121 to a main memory 113.

The CPU 111 also executes a system BIOS (Basic Input Output System) stored in the BIOS-ROM 120. The system BIOS is a program for hardware control.

The north bridge 112 is a bridge device which connects the south bridge 119 with a local bus of the CPU 111. The north bridge 112 incorporates a memory controller which controls access to the main memory 113. Further, the north bridge 112 has a function for executing communications with the graphics controller 114 via an AGP (Accelerated Graphics Port) bus.

The graphics controller 114 is a display controller, which controls an LCD 17 used as a display monitor of the computer 10. The graphics controller 114 displays video data written in a video memory (VRAM) 114A on the LCD 17.

The south bridge 119 controls devices on an LPC (Low Pin Count) bus and devices on a PCI (Peripheral Component Interconnect) bus. The south bridge 119 incorporates an IDE (Integrated Drive Electronics) controller to control the HDD 121 and ODD 122. Further, the south bridge 119 has a function for controlling the TV tuner 123 and a function for controlling access to the BIOS-ROM 120.

The HDD 121 is a storage device which stores various software and data. The optical disk drive (ODD) 123 is a drive unit to drive memory media, such as DVDs and CDs, which store video contents. The TV tuner 123 is a receiver to externally receive broadcast program data, such as TV broadcast program.

The network controller 125 is a communication apparatus, which executes communications with an external network. The network controller 125 is, for example, a wireless LAN controller in compliance with wireless LAN standards (IEEE 802.11 or the like). It can be connected to an access point (a radio relay station) for wireless LAN via an antenna 125A to perform radio communication. The network controller 125 may be constructed as a controller in compliance with radio communication standards other than the wireless LAN standards, for example, Bluetooth®, Wireless USB, Wireless Docking Station, etc.

The embedded controller/keyboard controller IC (EC/KBC) 124 is a one-chip microcomputer, in which an embedded controller to manage power and a keyboard controller to control the keyboard (KB) 13 and the touch pad 16 are integrated.

The power supply controller (PSC) 128 generates and supplies power necessary to the respective components of the computer 10 based on power from the battery 126 or external power externally supplied through the AC adapter 127 in accordance with instructions from the embedded controller (EC).

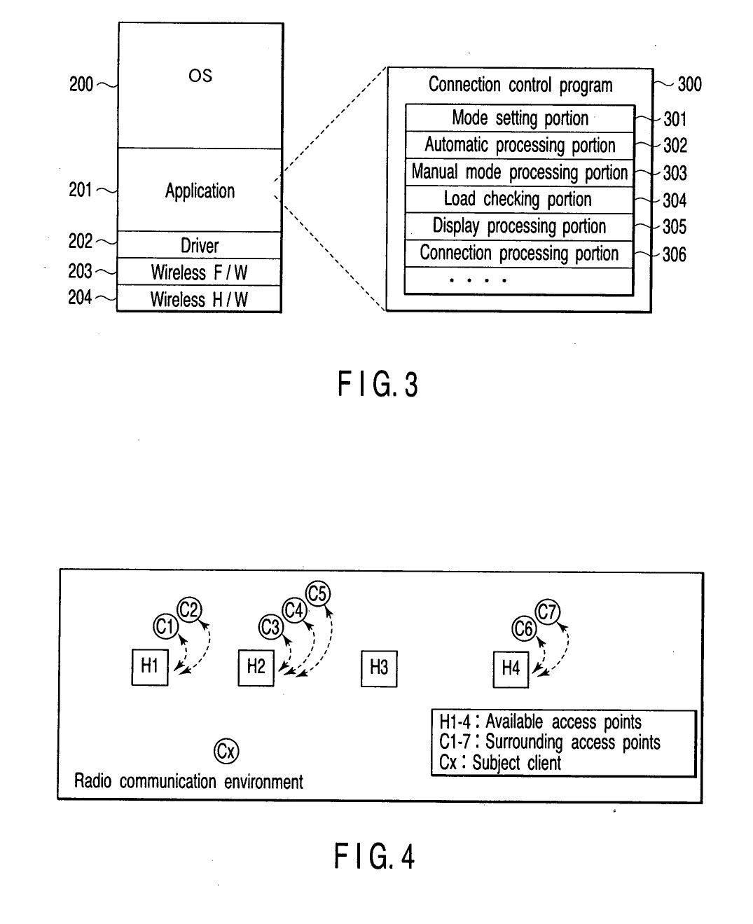

FIG. 3 is a block diagram showing a functional configuration relating to a radio communication function of the computer. Communication functions of the wireless LAN will be described below.

To realize the radio communication function of the computer 10, an operating system (OS) 200, an application 201, a driver 202, firmware 203, hardware 204, etc. are used.

The OS 200 manages various software, such as the application 201 and the driver 202. The application 201 includes a connection control program 300. When the computer 10 is to be wirelessly connected to one of access points (radio relay station) as a client, the connection control program 300 performs control to check communication loads at the respective access points and to achieve wireless connection with an access point of the lowest communication load. In general, the communication load at an access point is higher as the number of clients wirelessly connected to the access point is greater. Further, the communication load is influenced by the intensity of a signal to be transmitted.

The connection control program 300 may be constructed as a utility under the control of the OS 200. The driver 202 controls the network controller 125, which performs radio communication in accordance with a request from the connection control program 300. The firmware 203 is a program to perform basic controls relating to radio communication. The hardware 204 corresponds to hardware parts, such as the network controller 125 which performs radio communication.

The connection control program 300 includes a mode setting portion 301, an automatic mode processing portion 302, a manual mode processing portion 303, a load checking portion 304, a display processing portion 305, a connection processing portion 306, etc.

The mode setting portion 301 sets an operation mode when the computer 10 is connected to an access point. There are two operation modes: one is an automatic mode and the other is a manual mode. In the automatic mode, the program 300 automatically selects an access point to be wirelessly connected (or switched). In the manual mode, the user manually can select an access point to be wirelessly connected (or switched).

The automatic mode processing portion 302 executes processing sequences set as the automatic mode, when the automatic mode is set by the mode setting portion 301. In this case, functions of the load checking portion 304, the display processing portion 305, the connection processing portion 306, etc. are used, as will be described below.

The load checking portion 304 performs a process of checking of the respective communication loads at a plurality of access points, i.e., candidates to which the computer 10 is to be wirelessly connected. The load checking portion 304 can check the communication load of each of the access points by using information indicative of a sender and a destination contained in a data frame received by the access point.

The display processing portion 305 performs a process of displaying the state of each communication load checked by the load checking portion 304 on a screen such as the LCD 17. On the screen, information indicative of, for example, the connection relationship between each of the access points and the clients (the computer 10, the other computers, etc.) connected thereto, is displayed. If a new client is connected to the access point to which the computer 10 is connected, the display processing portion 305 can also display information indicative of the presence of the new client.

When the automatic mode is set, the connection processing portion 306 automatically selects an access point of the lowest communication load of the communication loads checked by the load checking portion, and executes wireless connection with the selected access point (or connection switch to the selected access point). When the manual mode is set, the connection processing portion 306 allows the user to manually selects any of the access points via the screen, and executes wireless connection with the access point (or connection switch to the access point) manually selected by the user.

FIG. 4 is a diagram showing an example of a radio communication environment, in which a plurality of clients are connected by radio waves to a plurality of preset access points.

In the example shown in FIG. 4, access points H1, H2, H3 and H4 are set in advance as access points available to the clients. Clients C1, C2, C3, C4, C5, C6 and C7 are present around these access points H1 to H4. The clients C1 and C2 are wirelessly connected to the access point H1. The clients C3, C4 and C5 are wirelessly connected to the access point H2. The clients C6 and C7 are wirelessly connected to the access point H4. In this example, the computer 10 is assumed to be a client Cx, which is going to be connected to any of the access points.

In the radio communication environment as described above, the client Cx can check the communication loads of the respective access points, and then achieve wireless connection with the access point of the lowest communication load (any one of the access points H1, H2, H3 and H4), by using the functions shown in FIG. 3.

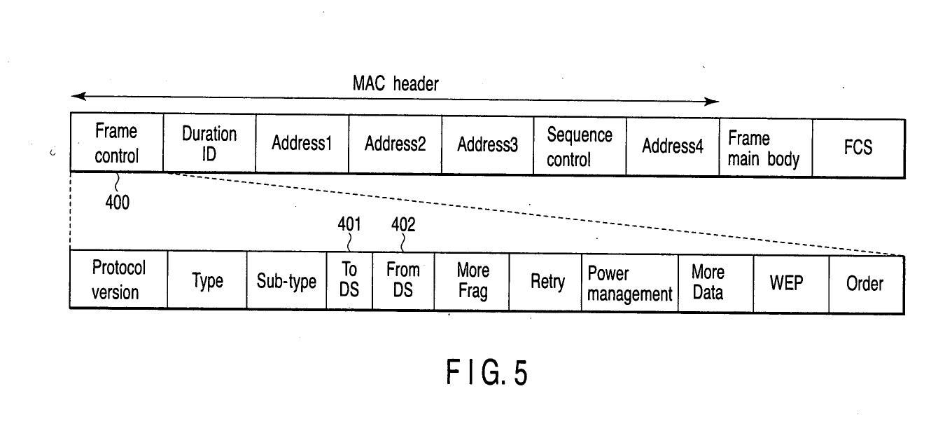

FIG. 5 is a diagram showing a configuration of a data frame transmitted between a client and an access point shown in FIG. 4.

The data frame shown in FIG. 5 is compliant with, for example, the wireless LAN standards (IEEE 802.11 or the like). The data frame has in its leading portion a MAC (Media Access Control) header, which each of the clients can decode. The MAC header includes a frame control portion 400 having control information relating to the frame. The frame control portion 400 contains destination information 401 indicative of the destination of the data frame, sender information 402 indicative of the sender of the data frame, etc.

The client Cx acquires the data frame as shown in FIG. 5, which is transmitted between each of the clients and each of the access points in the radio communication environment shown in FIG. 4. It extracts the MAC header from the data frame, fetches the frame control portion 400 from the MAC header, and further fetches the destination information 401 and the sender information 402 from the frame control portion 400. Then, it analyzes what client is connected to what access point. In the analysis, the client Cx may use either one or both of the data frame transmitted from the client to the access point and the data frame transmitted from the access point to the client. Further, it may acquire information, such as the receiving sensitivity, from the information contained in the MAC header. The result of the analysis is used to determine the communication loads of the respective access points.

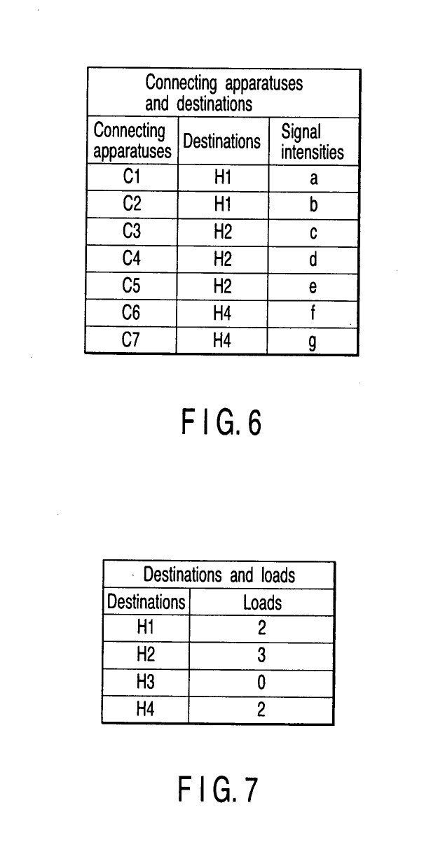

FIG. 6 is a diagram showing a result of an analysis performed by the client Cx shown in FIG. 4.

The client Cx shown in FIG. 4 accumulates information on “connecting apparatuses” (clients) and “destinations” (access points) by using destination information 401 and sender information 402 acquired from the headers of the respective data frames. It also accumulates “signal intensities” (intensities of the signals transmitted between the clients and the access points) detected through the headers of the respective data frames or the network controller 125. Then, the client Cx obtains an analysis result as shown in FIG. 6.

In the example shown in FIG. 6, the destination of the clients C1 and C2 is the access point H1, the destination of the clients C3, C4 and C5 is the access point H2, and the destination of the clients C6 and C7 is the access point H4 (that is, FIG. 6 shows the connecting state of FIG. 4). FIG. 6 also indicates that the signal intensities at the clients C1, C2, C3, C4, C5 and C6 are respectively a, b, c, d, e, f, and g.

FIG. 7 is a diagram showing a result of a load check performed by the client Cx shown in FIG. 4.

The client Cx shown in FIG. 4 determines the levels of the communication loads of the respective “destinations” (access points) as shown in FIG. 7, based on the result of the analysis shown in FIG. 6, and obtains a load check result. In the example shown in FIG. 7, the number of clients connected to each access point is directly indicated as a level of the communication load. However, the determination of the communication levels is not limited to this example, but may be performed by, for example, calculating predetermined weights in view of the signal intensities shown in FIG. 6.

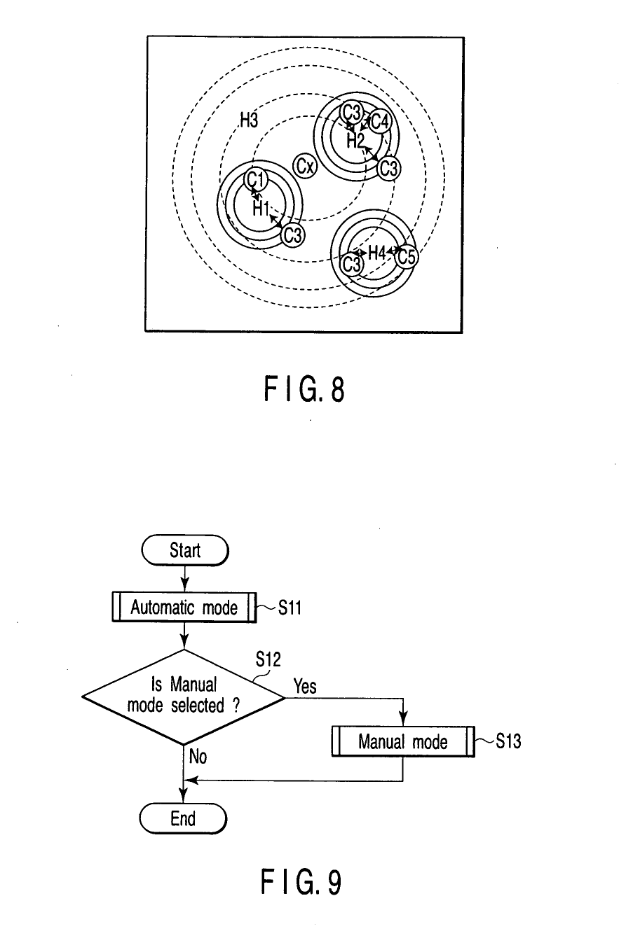

FIG. 8 is a diagram showing a connection and load status displayed on the screen of the client Cx based on the result of the analysis shown in FIG. 6 and the result of the load check shown in FIG. 7.

The client Cx in FIG. 4 displays map information as shown in FIG. 8 based on the result of the analysis shown in FIG. 6 and the result of the load check shown in FIG. 7. The information is displayed in consideration of, for example, the following matters.
The client Cx is displayed at the center of the map.
The position of each access point is proportional to the intensity of the signal received by the client Cx from the access point.
The clients connected to each access point are displayed around the access point.
The clients may be displayed or not displayed at the option of the user.
The access point and the client wirelessly connected thereto are connected with a solid line on the display. The solid line may be displayed or not displayed at the option of the user.
When a new client is connected to an access point, the new client is emphasized on the display.

Based on the displayed map information as described above, the user can easily understand the level of the load at each client, and the status of the clients connected to each access point. Further, since a new client connected to an access point is displayed on the screen, even if a suspicious person is illicitly connected to an access point, the user can easily recognize that situation. Furthermore, the user can easily instruct switching from one access point to another access point of a lower communication load based on the information displayed on the screen.

FIGS. 9 to 12 are flowcharts illustrating operations of the connection control program 300 shown in FIG. 3.

First, a mode setting operation will be described with reference to FIG. 9.

As described before, there are two operation modes: the automatic mode and the manual mode to connect the computer 10 and an access point. If the computer 10 is preset to the automatic mode, the connection control program 300 executes a connection control corresponding to the automatic mode (block S11).

The connection control program 300 monitors whether the user has performed a mode switching operation or not (block S12). For example, if the manual mode is selected, the connection control program 300 sets the manual mode, and executes a connection control corresponding to the manual mode (block S13).

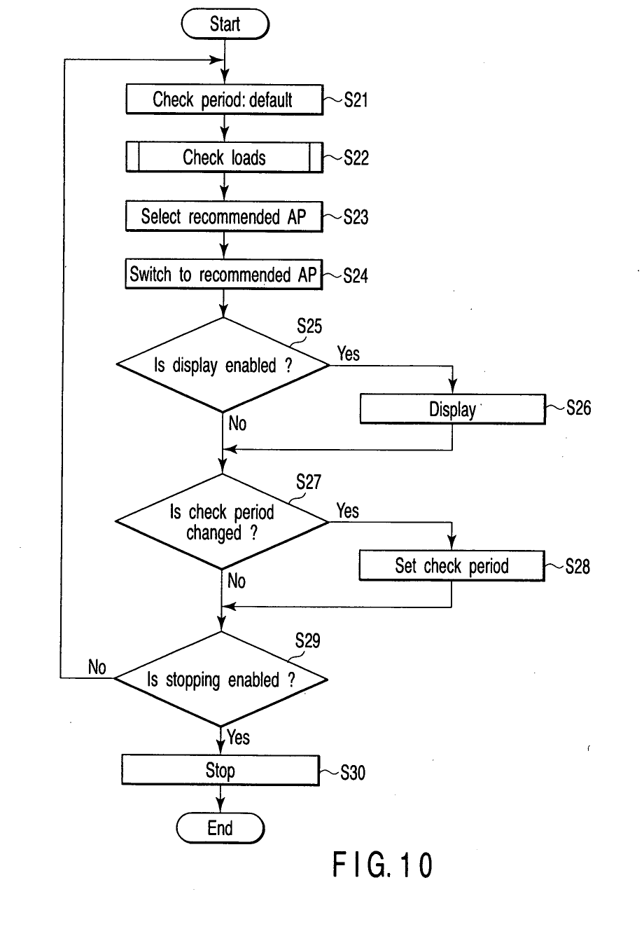

The automatic mode shown in FIG. 9 will now be described with reference to FIG. 10.

The connection control program 300 checks the communication loads at the respective access points at regular time intervals, and switches connection to, for example, an access point of the lowest communication load.

More specifically, each time a check period preset as a default elapses (block S21), the connection control program 300 checks the communication loads at the respective access points (block S22). Then, the connection control program 300 selects, for example, the access point of the lowest communication load (block S23), and switches the connection to that access point (block S24).

Further, the connection control program 300 determines whether the display function of the map information indicating the communication loads is set valid or invalid (block S25). If the display function is valid, the connection control program 300 generates the map information as shown in FIG. 8, using the result of the load check, and displays the generated map information (block S26).

Then, the connection control program 300 determines whether there is an intrusion for changing the setting of the check period (block S27). If there is an instruction for changing the setting of the check period, the connection control program 300 changes the setting of the check period as instructed (block S28).

Thereafter, the connection control program 300 determines whether there is an instruction for stopping of the control operation (block S29). If there is no instruction for stopping, the processes from the block S21 to S29 are repeated. If there is an instruction for stopping, the control operation of the automatic mode is stopped (block S30).

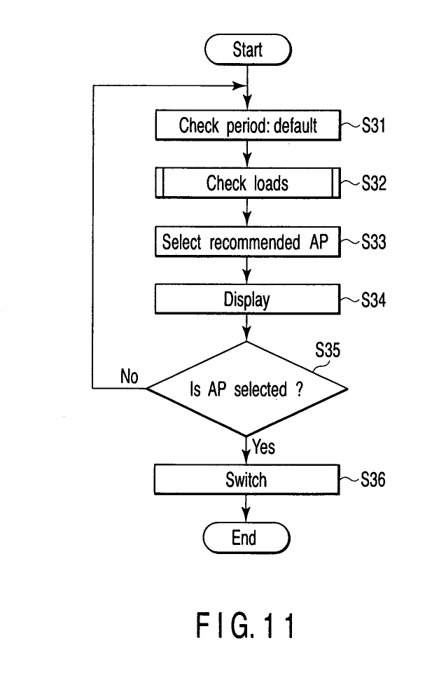

An operation of the manual mode shown in FIG. 9 will now be described with reference to FIG. 11.

The connection control program 300 checks the communication loads at the respective access points at regular time intervals, and displays recommendation of switching the connection to, for example, an access point of the lowest communication load. Then, the connection control program 300 switches the current accesses point to the access point selected by the user.

More specifically, each time a check period preset as a default elapses (block S31), the connection control program 300 checks the communication loads at the respective access points (block S32). Then, the connection control program 300 selects, for example, the access point of the lowest communication load (block S33).

The connection control program 300 generates the map information as shown in FIG. 8 by using the result of the load check or the like, and displays the generated map information. In the display, the selected access point, which has the lowest communication load, is recommended by means of highlight display or specific color display (block S34).

Further, the connection control program 300 determines whether the user has selected an access point through the screen (block S35). If not, the processes from the block S31 to S35 are repeated. If the user has selected an access point, the connection switch to the selected access point is executed (block S36).

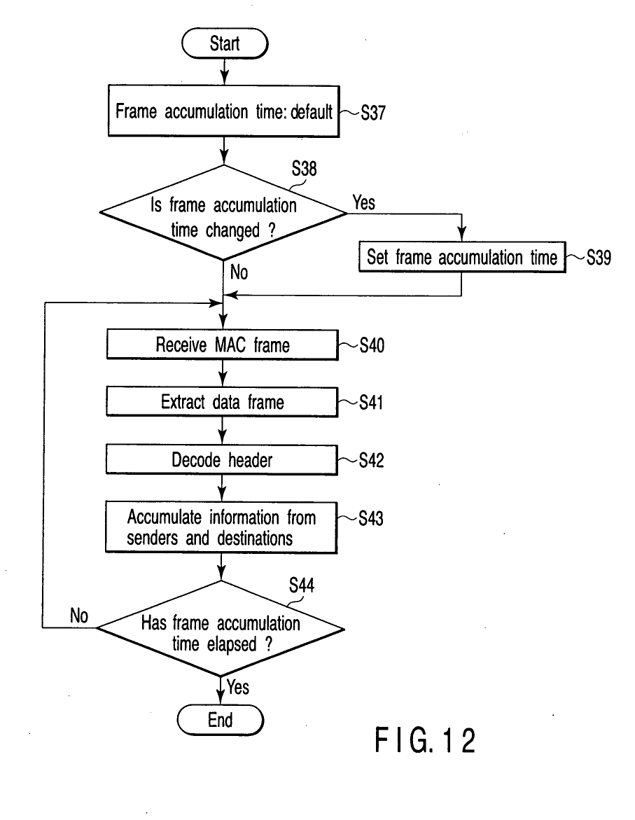

An operation of the load check shown in FIG. 11 will now be described with reference to FIG. 12.

The connection control program 300 accumulates information for the load check using the data frames at regular time intervals.

More specifically, the connection control program 300 acknowledges the frame accumulation time preset as a default (block S37), and determines whether there is an instruction for changing the setting of the frame accumulation time (block S38). If there is an instruction for changing the setting of the frame accumulation time, the connection control program 300 changes the setting of the frame accumulation time (block S39).

When the connection control program 300 detects reception of an MAC frame (block S40), it extracts the data frame (block S41), decodes the header (block S42), and accumulates the information from the respective senders and destinations (block S43).

Further, the connection control program 300 determines whether the frame accumulation time has elapsed (block S44). If not, the processes from the blocks S40 to S44 are repeated. If the frame accumulation time has elapsed, the operation of the load check is completed.

According to the embodiment detailed above, the following advantages are attained.
The computer can search for an access point of the smallest communication load, and enables connection thereto, so that the connection can be achieved at a higher speed.
Since the connection between an access point and the surrounding clients is displayed, the load at the access point can be checked. Therefore, the traffic can be reduced by changing the access point.
The computer can easily recognize if a suspicious person is connected to an access point. Particularly in an environment crowded with companies or houses, since a wave from the user's computer reaches a third party's computer, there is a possibility that the user's computer may be used by the third party though the network. According to the present invention, since the user can visually recognize the clients connected to an access point and can be immediately notified of an illegal entry by a suspicious person, the possibility of an attack by the suspicious person is suppressed to the minimum.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a load check portion which checks communication loads at a plurality of radio relay stations; and
a connection processing portion which executes wireless connection with a radio relay station of a lowest communication load of the communication loads checked by the load check portion.

2. The information processing apparatus according to claim 1, wherein the load check portion checks the communication loads of the plurality of radio relay stations by using information indicative of a destination and a sender contained in data frames transmitted and received by the plurality of radio relay stations.

3. The information processing apparatus according to claim 1, further comprising a display processing portion which displays statuses of the communication loads of the plurality of radio relay stations checked by the load check portion on a screen.

4. The information processing apparatus according to claim 3, wherein the display processing portion displays a connection relationship between each of the plurality of radio relay stations and an apparatus connected thereto.

5. The information processing apparatus according to claim 4, wherein when an apparatus is newly connected to the radio relay station to which the information processing apparatus is connected, the display processing portion displays information indicative of presence of the newly connected apparatus.

6. The information processing apparatus according to claim 1, wherein the connection processing apparatus is configured to execute wireless connection with a radio relay station selected by an input operation.

7. A connection control method of controlling connection of an information processing apparatus configured to be connected to one of a plurality of radio relay stations, the method comprising:
checking communication loads at the plurality of radio relay stations; and
executing wireless connection with a radio relay station of a lowest communication load of the checked communication loads.

8. The connection control method according to claim 7, wherein the communication loads of the plurality of radio relay stations are checked by using information indicative of a destination and a sender contained in data frames transmitted and received by the plurality of radio relay stations.

9. The connection control method according to claim 7, further comprising displaying statuses of the checked communication loads of the plurality of radio relay stations on a screen.

10. The connection control method according to claim 9, further comprising displaying on a screen a connection relationship between each of the plurality of radio relay stations and apparatuses connected thereto.

11. The connection control method according to claim 10, further comprising, when an apparatus is newly connected to the radio relay station to which the information processing apparatus is connected, displaying information indicative of presence of the newly connected apparatus.

12. The connection control method according to claim 7, further comprising executing wireless connection with a radio relay station selected by an input operation.
